(19) United States
(12) Patent Application Publication
(10) Pub. No.: US 2026/0141416 A1
(43) Pub. Date: May 21, 2026

(54) Method and System for Determining Countermeasure Against Service Quality Degradation

(71) Applicant: Hitachi, Ltd., Chiyoda-ku, Tokyo (JP)

(72) Inventor: Yuta MUTO, Tokyo (JP)

(21) Appl. No.: 19/119,448

(22) PCT Filed: Nov. 22, 2023
(86) PCT No.: PCT/JP2023/042001

§ 371 Date: Apr. 9, 2025

(30) Foreign Application Priority Data
Dec. 5, 2022 (JP) 2022-194461

(51) Int. Cl. G06Q 30/0201; G06F 11/34

(52) U.S. Cl. CPC G06Q 30/0206; G06F 11/3409

(57) ABSTRACT

A method for determining, by a system, a countermeasure against quality degradation in a service provided by a service provision device is disclosed. The system stores countermeasure cost information indicating a relation between a countermeasure candidate and a cost. The method includes, by the system: predicting service quality degradation based on monitoring information of service quality; estimating, based on the countermeasure cost information, a countermeasure cost required for each countermeasure candidate of a quality item for which the service quality degradation is predicted; and determining the countermeasure based on the estimated countermeasure cost.

### CROSS-REFERENCE TO RELATED APPLICATION

The present application claims the priority of Japanese Patent Application No. 2022-194461, filed on Dec. 5, 2022, the entire contents of which are incorporated herein by reference.

### TECHNICAL FIELD

The invention relates to determination of a countermeasure against service quality degradation.

### BACKGROUND ART

In communication service, risk events are classified into a “service event part”, a “risk event part”, and a “system event part”, a corresponding level value is described in a “corresponding level value part”, a countermeasure proposal is extracted in a “countermeasure content part”, a countermeasure cost is described in a “cost part”, and a negative factor is described in a “constraint part”. JP2019-149157A describes a technique for selecting a countermeasure to be actually applied from a “cost part”, a “constraint part”, and a “remaining risk part” when a plurality of countermeasure proposals are proposed.

In addition, a technique is known in which a communication quality prediction device includes a log collection unit that collects a communication quality log collected from a user terminal or various logs collected from a communication facility or a provider server in a carrier network, a change point detection unit that detects a change point from data obtained by time-series analyzing the communication quality log, and a prediction analysis unit that executes generation of a model and prediction of communication quality by excluding a log before the change point from data obtained by time-series analyzing the communication quality log for each area (JP2016-91271A).

### SUMMARY OF INVENTION

### Technical Problem

In general, a service provider presents, to a service subscriber, protocols such as service level agreement (SLA) that clearly indicates how much service quality can be guaranteed, and takes countermeasures at a high cost so as not to fall below the presented service quality.

However, it is difficult to determine how much cost is to be spent to take countermeasures before the service quality falls below the presented service quality. In JP2019-149157A, a countermeasure to be actually taken is determined based on a cost, restriction, and remaining risk. However, it is not known when the service quality falls below the presented service quality, and therefore, it is necessary to always take a countermeasure at a high cost.

In JP2016-91271A, generation of a model and prediction of communication quality are executed by excluding a log before the change point from data obtained by performing time-series analysis on a communication quality log for each area. However, when degradation in communication quality is predicted, it is not possible to determine how much cost is to be taken to take countermeasures.

### Solution to Problem

According to one aspect of the invention, there is provided a method for determining, by a system, a countermeasure against quality degradation in a service provided by a service provision device. The system stores countermeasure cost information indicating a relation between a countermeasure candidate and a cost. The method includes, by the system: predicting service quality degradation based on monitoring information of service quality; estimating, based on the countermeasure cost information, a countermeasure cost required for each countermeasure candidate of a quality item for which the service quality degradation is predicted; and determining the countermeasure based on the estimated countermeasure cost.

### Advantageous Effects of Invention

According to one aspect of the invention, countermeasures against service quality degradation can be determined more appropriately.

The details of at least one embodiment of the subject matter disclosed in the present description will be described in the accompanying drawings and the following description. Other features, aspects, and effects of the disclosed subject matter will be clarified by the following disclosure, drawings, and claims.

### BRIEF DESCRIPTION OF DRAWINGS

FIG. 1 is a block diagram showing a configuration of a computer system that implements a quality degradation countermeasure according to Embodiment 1.

FIG. 2 is a diagram showing an example of a service quality degradation prediction table according to Embodiment 1.

FIG. 3 is a diagram showing an example of a countermeasure cost table according to Embodiment 1.

FIG. 4 is a diagram showing an example of a countermeasure determination result screen of an interface device according to Embodiment 1.

FIG. 5 is a flowchart showing a quality degradation countermeasure processing procedure according to Embodiment 1.

FIG. 6 is a diagram showing an example of a service quality prediction table based on a communication state and a device state according to Embodiment 2.

FIG. 7 is a flowchart showing a service quality prediction processing procedure based on a communication state and a device state according to Embodiment 2.

FIG. 8 is a diagram showing an example of a countermeasure cost calculation table for each service according to Embodiment 3.

FIG. 9 is a flowchart showing an estimation processing procedure of a countermeasure cost based on a cost calculation table for each service according to Embodiment 3.

FIG. 10 is a diagram showing an example of a countermeasure priority table for each service according to Embodiment 4.

FIG. 11 is a flowchart showing a determination processing procedure of a countermeasure based on a countermeasure priority for each service according to Embodiment 4.

FIG. 12 is a block showing a configuration of a quality degradation countermeasure device including a damage cost estimation unit according to Embodiment 5.

FIG. 13 is a diagram showing an example of a damage cost estimation table according to Embodiment 5.

FIG. 14 is a diagram showing an example of a countermeasure determination result display screen including an estimated damage cost of an interface device according to Embodiment 5.

FIG. 15 is a flowchart showing an estimation processing procedure of a damage cost that occurs during service quality degradation according to Embodiment 5.

FIG. 16 is a diagram showing an example of a service quality-damage cost estimation table based on a predicted degree of service quality degradation according to Embodiment 6.

FIG. 17 is a flowchart showing an estimation processing procedure of a damage cost based on the predicted degree of service quality degradation according to Embodiment 6.

FIG. 18 is a diagram showing an example of an influence range-damage cost estimation table based on a predicted influence range of service quality degradation according to Embodiment 7.

FIG. 19 is a flowchart showing an estimation processing procedure of a damage cost based on the predicted influence range of service quality degradation according to Embodiment 7.

FIG. 20 is a diagram showing an example of a damage cost correction table according to Embodiment 8 when service quality degradation is not permitted.

FIG. 21 is a flowchart showing an embodiment of a damage cost correction processing procedure according to Embodiment 8 when the service quality degradation is not permitted.

FIG. 22 is a diagram showing an example of a damage cost calculation table for each service according to Embodiment 9.

FIG. 23 is a flowchart of a damage cost estimation processing procedure based on cost calculation data for each service according to Embodiment 9.

FIG. 24 is a diagram showing an example of a service quality degradation occurrence probability table according to Embodiment 10.

FIG. 25 is a flowchart showing a countermeasure determination processing procedure based on an occurrence probability of service quality degradation according to Embodiment 10.

### DESCRIPTION OF EMBODIMENTS

Hereinafter, for the sake of convenience, description will be made by being divided into a plurality of sections or embodiments as needed, but unless otherwise stated, those are not unrelated to one another, and are in a relation that one is a modification, details, supplementary description, and the like of a part or all of the other ones. Hereinafter, when referring to the number or the like of elements (including the number, a numerical value, an amount, a range, or the like), the number of elements is not limited to a specific number, and may be the specific number or more or the specific number or less, unless otherwise specified or except a case where the number is apparently limited to a specific number in principle.

### Embodiment 1

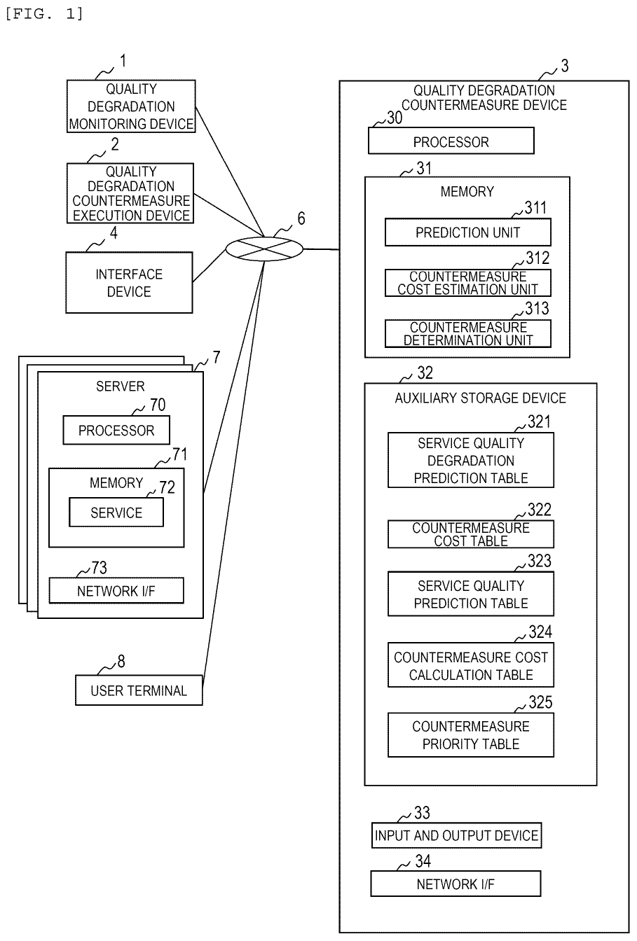

FIG. 1 shows a configuration example of a quality degradation countermeasure system that implements a quality degradation countermeasure. The system includes a quality degradation monitoring device 1, a quality degradation countermeasure execution device 2, and an interface device 4.

The quality degradation countermeasure system monitors quality of a service provided from a server 7 to a user terminal 8 via a network 6. The server 7 can provide a plurality of services to a plurality of user terminals 8. In the configuration example of FIG. 1, the server 7 includes a processor 70, a memory 71, and a network interface 73, and the processor 70 provides a service according to a service program 72.

The quality degradation countermeasure system predicts service quality degradation based on a service monitoring result, estimates, based on the prediction of the quality degradation, a countermeasure cost required for a countermeasure of the quality degradation, and determines, based on the countermeasure cost, a countermeasure to be implemented.

The quality degradation monitoring device 1 acquires information used for prediction 0 the service quality degradation from the server 7 and/or the user terminal 8. A quality degradation countermeasure device 3 predicts the service quality degradation, estimates, based on the prediction of the service quality degradation, the countermeasure cost required for the countermeasure, and determines the countermeasure based on the estimated countermeasure cost. The quality degradation countermeasure execution device 2 executes the quality degradation countermeasure. The interface device 4 displays a prediction result of the service quality degradation, an estimation result of the countermeasure cost, and a determination result of the quality degradation countermeasure.

The quality degradation countermeasure device 3 includes a processor 30, a memory 31 that is a main storage device, an auxiliary storage device 32, an input and output device 33, and a network interface 34. Each part of an information processing device 101 is communicably connected to each other via a communication unit such as a bus (not shown). All or a part of the configuration of the information processing device 101 may be implemented by a virtual resource such as a cloud server.

The processor 30 is implemented using a central processing unit (CPU), a micro processing unit (MPU), a graphics processing unit (GPU), or the like. When the processor 30 reads and executes a program stored in the memory 31, a function of the quality degradation countermeasure device 3 is implemented.

The memory 31 is a device for storing programs and data and is, for example, a read only memory (ROM), a random access memory (RAM), and a non-volatile RAM (NVRAM).

The auxiliary storage device 32 is, for example, a solid state drive (SSD), an NVRAM such as an SD memory card, an optical storage device such as a compact disc (CD) or a digital versatile disc (DVD), a hard disc drive (HDD), or a storage area of a cloud server. The auxiliary storage device 32 includes a non-transitory storage medium that stores programs and data. The programs and data stored in the auxiliary storage device 32 are read into the memory 31 as needed.

The input and output device 33 is an interface that receives input of information and outputs various types of information. Examples of the input device include a keyboard, a mouse, a touch panel, a card reader, and a microphone. Examples of the output device include a screen display device such as a liquid crystal display (LCD) and a graphic card, a printing device, and a voice output device such as a speaker. A part of the components shown in FIG. 1 may be omitted, and other components may be added.

The memory 31 includes a prediction unit 311, a countermeasure cost estimation unit 312, and a countermeasure determination unit 313, and stores various programs. The processor 30 can store the information received from the quality degradation monitoring device 1 in the auxiliary storage device 32. The processor 30 operates as a corresponding functional unit by performing processing together with other components according to these programs.

Examples of the information stored in the auxiliary storage device 32 include a service quality degradation prediction table 321 and a countermeasure cost table 322 that stores an estimation result of a countermeasure cost of a countermeasure candidate. Further, examples thereof include a service quality prediction table 323 that stores information on a prediction result of service quality based on a communication state and device state, a countermeasure cost calculation table 324 for each service, and a countermeasure priority table 325 for each service that stores a countermeasure based on a countermeasure priority. The information stored in the auxiliary storage device 32 may be read, written, and rewritten by the interface device 4.

The description of the hardware configuration of the quality degradation countermeasure device 3 can be applied to the quality degradation monitoring device 1, the quality degradation countermeasure execution device 2, the interface device 4, and the user terminal 8. Note that this configuration is merely an example of the configuration, and there is no restriction on the physical configuration. For example, the quality degradation countermeasure device 3 may have a physical configuration on the same device as the quality degradation monitoring device 1, the quality degradation countermeasure execution device 2, or the interface device 4.

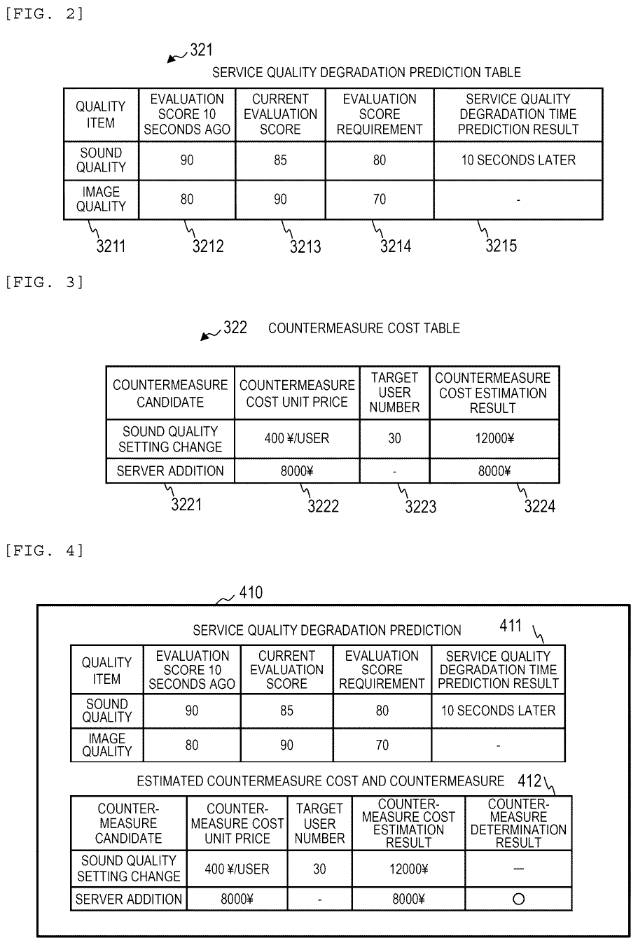

FIG. 2 is an example of the service quality degradation prediction table 321. A quality item 3211 is identification information of an item for which the service quality degradation is predicted. An evaluation score 10 seconds ago 3212 is a score obtained by evaluating service quality of each quality item 10 seconds ago. A current evaluation score 3213 is a score obtained by currently evaluating the service quality of each quality item.

An evaluation score requirement 3214 is a score at or below which the service quality is determined to degrade when score obtained by evaluating the service quality of each quality item falls. A service quality degradation time point prediction result 3215 is a value indicating, as a result of the prediction of the service quality degradation, how much time is expected from now before the service quality degrades. A method for predicting the service quality degradation will be described below.

FIG. 3 is an example of the countermeasure cost table 322 indicating estimation of a countermeasure cost and determination of a countermeasure. A countermeasure candidate 3221 is identification information of a candidate for a countermeasure for preventing service quality degradation. A countermeasure cost unit price 3222 is a unit price of a countermeasure cost required to execute each countermeasure candidate. A target user number 3223 is the number of users who are execution targets of each countermeasure candidate. A countermeasure cost estimation result 3224 is an estimation result of a countermeasure cost required to execute each countermeasure candidate. A method for estimating the countermeasure cost will be described below.

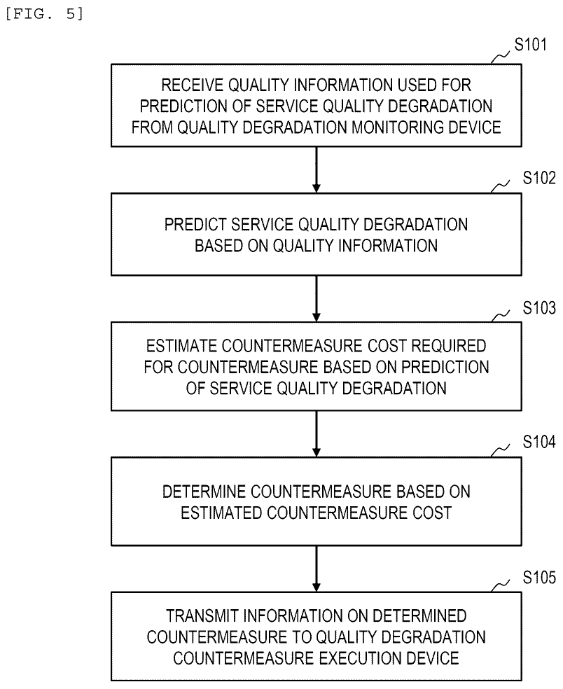

FIG. 4 shows an example of a display screen 410 of a countermeasure determination result of the interface device 4. The screen 410 includes a service quality degradation prediction 411 and an estimated countermeasure cost and countermeasure 412. The service quality degradation prediction 411 has the same column as the service quality degradation prediction table 321.

In the service quality degradation prediction 411, the quality item is identification information of an item for which the service quality degradation is predicted. The evaluation score 10 seconds ago is a score obtained by evaluating the service quality of each quality item 10 seconds ago. The current evaluation score is a score obtained by currently evaluating the service quality of each quality item. The evaluation score requirement is a score at or below which the service quality is determined to degrade when score obtained by evaluating the service quality of each quality item falls. The service quality degradation time point prediction result is a value indicating, as a result of the prediction of the service quality degradation, how much time is expected from now before the service quality degrades. A method for predicting the service quality degradation will be described below.

The estimated countermeasure cost and countermeasure 412 has a countermeasure determination result column in addition to the columns of the countermeasure cost table 322. In the estimated countermeasure cost and countermeasure 412, the countermeasure candidate is identification information of a candidate of a countermeasure for preventing service quality degradation. The countermeasure cost unit price is a unit price of a countermeasure cost required to execute each countermeasure candidate. The target user number is the number of users who are execution targets of each countermeasure candidate. The countermeasure cost estimation result is an estimation result of a countermeasure cost required to execute each countermeasure candidate. A method for estimating the countermeasure cost will be described below. The countermeasure determination result is information indicating which countermeasure candidate has been selected as a countermeasure for preventing service quality degradation. As the countermeasure determination result, for example, “∘” may be set to the selected countermeasure candidate, and “−” may be set to the unselected countermeasure candidate.

FIG. 5 is a flowchart showing an embodiment of a quality degradation countermeasure processing procedure. The processing based on Embodiment 1 shown in the flowchart of FIG. 5 is, for example, as follows. The processing of this flowchart is executed, for example, at a predetermined cycle.
Step S101: The processor 30 receives quality information used for prediction of service quality degradation from the quality degradation monitoring device 1. The quality information may include, for example, an evaluation score obtained by evaluating the sound quality of the received voice or the image quality of the received video by the receiver of a telepresence service, or an evaluation time point. Further, the processor 30 may receive information for use other than the prediction of the service quality degradation from the quality degradation monitoring device 1. For example, in this step, the processor 30 may receive, from the quality degradation monitoring device 1, information such as the number of high-sound quality plan users of the telepresence service used for estimation of the countermeasure cost.
Step S102: The prediction unit 311 predicts the service quality degradation based on the quality information received in step S101, and stores the information in the service quality degradation prediction table 321. For example, it is assumed that the quality information received in step S101 is an evaluation score obtained by evaluating the sound quality of the voice or the image quality of video received in the telepresence service and the evaluation time point. As in the service quality degradation prediction table 321 shown in FIG. 2, the prediction unit 311 records the evaluation score 10 seconds ago 3212 and the current evaluation score 3213 for each of the sound quality and the image quality in the quality item 3211.

The prediction unit 311 predicts an occurrence time point of the service quality degradation based on the values of the evaluation score 10 seconds ago 3212 and the current evaluation score 3213, and the evaluation score requirement 3214. The prediction result may be recorded as the service quality degradation time point prediction result 3215. At this time, the evaluation score requirement may be preset. In the prediction of the service quality degradation time point, for example, assuming that a change rate between the evaluation score 10 seconds ago and the current evaluation score is constant in the future, the time point at which the evaluation score requirement is s exceeded may be calculated. That is, when the evaluation score 10 seconds ago is A, the current evaluation score is B, and the evaluation score requirement is C, 10×(B−C)/(A−B) seconds later may be recorded as the service quality degradation time point prediction result.

At this time, when a value of (B−C) is negative, that is, the current evaluation score is already less than the evaluation score requirement, or when a value of (A−B) is negative, that is, the current evaluation score is higher than the evaluation score 10 seconds ago, the service quality degradation time point prediction result may be set to “−” indicating no value.
Step S103: The countermeasure cost estimation unit 312 estimates a countermeasure cost required for a countermeasure based on the prediction of the service quality degradation and stores the estimated countermeasure cost in the countermeasure cost table 322. For example, as a result of the prediction of the service quality degradation in step S102, it is assumed that the service quality degradation time point prediction result does not have a value as in the service quality degradation prediction table 321 shown in FIG. 2. That is, it is assumed that the quality item for which the service quality degradation has been predicted is “sound quality”. As in the countermeasure cost table 322 shown in FIG. 3, the countermeasure cost estimation unit 312 may estimate the countermeasure cost based on the countermeasure candidate, the countermeasure cost unit price, and the target user number and record the estimated countermeasure cost as the countermeasure cost estimation result.

At this time, the countermeasure candidate and the countermeasure cost unit price corresponding to degradation in each quality such as the degradation in the sound quality may be preset. The countermeasure candidates for the degradation in the sound quality may include, for example, “sound quality setting change” and “server addition”. The “sound quality setting change” means changing the sound quality setting of the service by, for example, switching to normal sound quality to reduce the data volume for a user who uses the service with high sound quality, such as a subscriber of a high-sound quality plan. In the “server addition”, for example, a server that performs processing such as transmission and reception of a voice is added.

As the countermeasure cost unit price 3222, for example, a difference in the user unit prices between the high-sound quality plan and the normal sound quality plan in the countermeasure candidate “sound quality setting change”, a usage fee of the server in the countermeasure candidate “server addition”, or the like may be set.

As the target user number 3223, for example, the target user number for each countermeasure candidate may be calculated based on information acquired from the quality degradation monitoring device 1. For example, when the information acquired from the quality degradation monitoring device 1 includes the number of high-sound quality plan users of the telepresence service and the value of the number of high-sound quality plan users of the telepresence service is “30”, the target user number of the countermeasure candidate “sound quality setting change” may be set to “30” as in the countermeasure cost table 322 shown in FIG. 3.

When the countermeasure candidate does not depend on the target user number, “−” indicating no value may be set in the target user number. For example, when the countermeasure cost of “server addition” is constant regardless of the target user number, “−” may be set in the target user number of the countermeasure candidate “server addition” as in the countermeasure cost table 322 shown in FIG. 3. As the countermeasure cost estimation result, for example, a product of the countermeasure cost unit price and the target user number may be set for each countermeasure candidate.

For example, as in the countermeasure cost table 322 shown in FIG. 3, when “400¥/user” is set in the countermeasure cost unit price of the countermeasure candidate “sound quality setting change” and “30” is set in the target user number, 400×30=12000¥ may be set in the countermeasure cost estimation result of the countermeasure candidate “sound quality setting change”. When “−” indicating no value is set in the target user number, the value set in the countermeasure cost unit price may be set in it is in the countermeasure cost estimation result.

For example, as in the countermeasure cost table 322 shown in FIG. 3, when “8000¥” is set in the countermeasure cost unit price of the countermeasure candidate “server addition” and “−” is set in the target user number, 8000¥ set in the countermeasure cost unit price may be set in the countermeasure cost estimation result of the countermeasure candidate “server addition”.
Step S104: The countermeasure determination unit 313 determines the countermeasure based on the countermeasure cost estimated in step S103. In the determination of the countermeasure, for example, the countermeasure cost estimation results estimated in step S103 may be compared between the countermeasure candidates, and the countermeasure candidate having the minimum countermeasure cost estimation result may be determined as the countermeasure.

For example, when the countermeasure cost estimation result estimated in step S103 is expressed as in the countermeasure cost table 322 shown in FIG. 3, the countermeasure cost estimation result “12000¥” of the countermeasure candidate “sound quality setting change” and the countermeasure cost estimation result “8000¥” of the countermeasure candidate “server addition” may be compared, and the countermeasure candidate “server addition” having the minimum countermeasure cost estimation result may be determined as the countermeasure.

The countermeasure determination unit 313 may transmit the determination result of the countermeasure to the interface device 4, and the interface device 4 may display the determination result of the countermeasure, for example, as shown in FIG. 4. In the example illustrated in FIG. 4, the countermeasure determination unit 313 transmits the information on the prediction result indicated by the service quality degradation prediction table 321 and the information on the determination result of the countermeasure to the interface device 4. The interface device 4 displays the received information on a display device.
Step S105: The processor 30 transmits information on the countermeasure determined in step S104 to the quality degradation countermeasure execution device 2. For example, when the countermeasure candidate is expressed as in the countermeasure cost table 322 shown in FIG. 3, the information on the countermeasure may include a name of the countermeasure candidate “server addition” determined as the countermeasure in step S104. The quality degradation countermeasure execution device 2 executes a quality degradation countermeasure based on the received countermeasure information. For example, when the countermeasure candidate determined as the countermeasure in step S104 is “server addition”, a server that performs processing such as transmission and reception of a voice may be added.

### Embodiment 2

In the present embodiment, the prediction unit 311 according to Embodiment 1 executes the prediction of the service quality degradation based on a communication state such as delay and throughput, and a device state such as a CPU usage rate and a memory usage rate. Accordingly, the service quality degradation can be predicted based on objectively measurable data, and therefore, an effect of improving the prediction accuracy of the service quality degradation is expected. In addition, the service quality degradation is predicted based on the state of the communication or the device, and therefore, it is possible to distinguish which state is the cause of the service quality degradation, and an effect of setting an appropriate countermeasure candidate according to the cause is expected.

In Embodiment 2, for example, information indicating a communication state such as delay and throughput and a state of the server 7 (device) such as a CPU usage rate and a memory usage rate is received in step S101 in the flowchart of Embodiment 1 shown in FIG. 5, and processing of executing the prediction of the service quality degradation based on the communication state such as delay and throughput and the device state such as a CPU usage rate and a memory usage rate is added in step S102. The information indicating the device state may be one or both of the CPU usage rate and the memory usage rate, or may be another type of numerical value. The information indicating the communication state may be one or both of the delay and the throughput, or may be another type of numerical value. Only one or both of the communication information and the device information may be referred to.

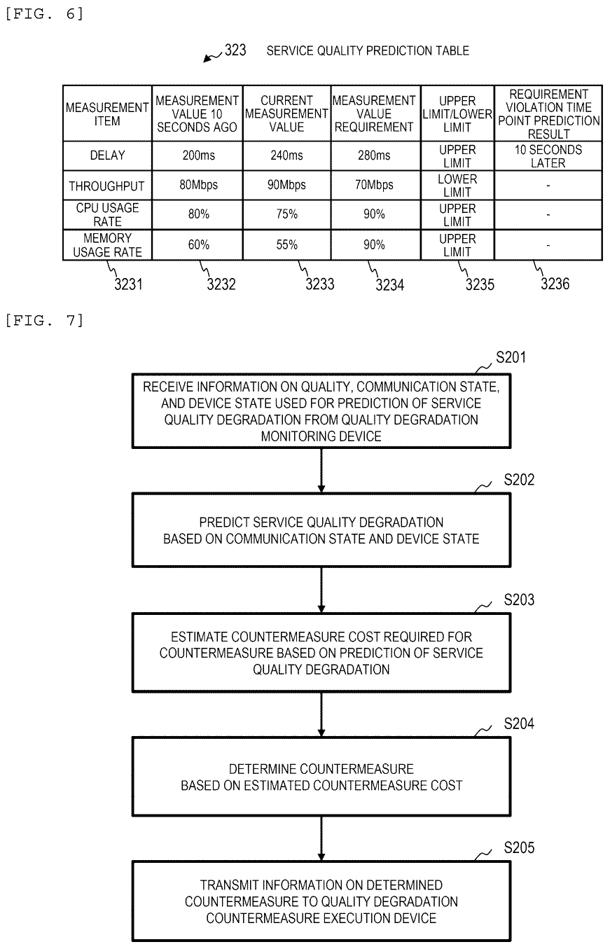

FIG. 6 shows an example of the service quality prediction table 323 based on the communication state and the device state. The measurement item 3231 is measurement target identification information indicating a communication state and a device state. A measurement value 10 seconds ago 3232 is a value obtained by measuring each measurement item 10 seconds ago. A current measurement value 3233 is a value obtained by currently measuring each measurement item. A measurement value requirement is a value at or above which, or at or below which, a measurement value of each measurement item is determined to violate a requirement of the measurement value. Whether a measurement value is determined to violate the requirement of the measurement value when it is equal to or greater than the value, or when it is equal to or less than the value, may be preset for each measurement item.

An upper limit/lower limit 3235 is identification information indicating whether the value set in the measurement value requirement corresponds to which requirement of the upper limit or the lower limit. For example, when the value set in the upper limit/lower limit is “upper limit”, a measurement value equal to or greater than the value is determined as a requirement violation. When the value set in the upper limit/lower limit is “lower limit”, a measurement value equal to or less than the value is determined as a requirement violation. A requirement violation time point prediction result 3236 is a value indicating, as a result of the prediction of the requirement violation of the measurement value, how much time has elapsed from the present when the requirement violation of the measurement value is predicted to occur. A method for predicting a requirement violation time point of a measurement value will be described below.

The processing based on Embodiment 2 shown in a flowchart in FIG. 7 is, for example, as follows. The processing of this flowchart is executed, for example, at a predetermined cycle.
Step S201: The processor 30 receives, from the quality degradation monitoring device 1, information indicating a communication state such as delay and throughput and a device state such as a CPU usage rate and a memory usage rate in addition to the information in step S101.
Step S202: The prediction unit 311 predicts service quality degradation based on the communication state such as the delay and throughput and the device state such as the CPU usage rate and the memory usage rate, which are received in step S201.

For example, it is assumed that information indicating the communication state received in step S201 is a measurement value of the delay and throughput, and information indicating the device state is a measurement value of the CPU usage rate and the memory usage rate. As in the service quality prediction table 323 shown in FIG. 6, the prediction unit 311 may record the measurement value 10 seconds ago and the current measurement value for each of the delay and throughput, and the CPU usage rate and memory usage rate. The prediction unit 311 may predict an occurrence time point of the requirement violation based on the measurement value requirement and record the occurrence time point as the requirement violation time point prediction result.

At this time, the measurement value requirement may be preset. In the prediction of the requirement violation time, for example, the time point at which the measurement value requirement is violated may be predicted on the assumption that the change rate between the measurement value 10 seconds ago and the current measurement value is constant in the future. That is, when the measurement value 10 seconds ago is A, the current measurement value is B, and the measurement value requirement is C, 10×(B−C)/(A−B) seconds later may be recorded as the requirement violation time point prediction result.

At this time, regarding the throughput which is a measurement item for which “lower limit” is set in the upper limit/lower limit 3235 of the service quality prediction table 323, when a value of (B−C) is negative, that is, the current measurement value is already less than the measurement value requirement, or when a value of (A−B) is negative, that is, the current measurement value is higher than the measurement value 10 seconds ago, the requirement violation time point prediction result 3236 may be set to “−” indicating no value.

Similarly, regarding the delay, the CPU usage rate, and the memory usage rate, which are measurement items for which “upper limit” is set in the upper limit/lower limit 3235 of the service quality prediction table 323, when the value of (B−C) is positive, that is, the current measurement value already exceeds the measurement value requirement, or when the value of (A−B) is positive, that is, the current measurement value is lower than the measurement value 10 seconds ago, the requirement violation time point prediction result 3236 may be set to “−” indicating no value.

A method for predicting the service quality degradation based on the requirement violation of the communication state or the device state may be preset, for example. For example, a requirement violation threshold MON may be preset, and when the requirement violation of N or more measurement values is predicted within M seconds, it may be determined that the service quality degradation is predicted.
Step S203: The countermeasure cost estimation unit 312 estimates, based on the prediction of the service quality degradation, a countermeasure cost required for a countermeasure in the same manner as in step S103.
Step S204: The countermeasure determination unit 313 determines the countermeasure in the same manner as in step S104.
Step S205: The processor 30 transmits information on the determined countermeasure to the quality degradation countermeasure execution device 2 in the same manner as in step S105.

### Embodiment 3

In the present embodiment, the estimation of the countermeasure cost by the countermeasure cost estimation unit 312 according to Embodiment 1 is executed based on cost calculation data for each service. Accordingly, the cost calculation data suitable for each service can be referred to, and therefore, an effect of improving the estimation accuracy of the countermeasure cost is expected.

In Embodiment 3, for example, information indicating a name of a service being executed is received in step S101 in the flowchart of Embodiment 1 shown in FIG. 5, and processing of executing estimation of a countermeasure cost based on the cost calculation data for each service is added in step S103.

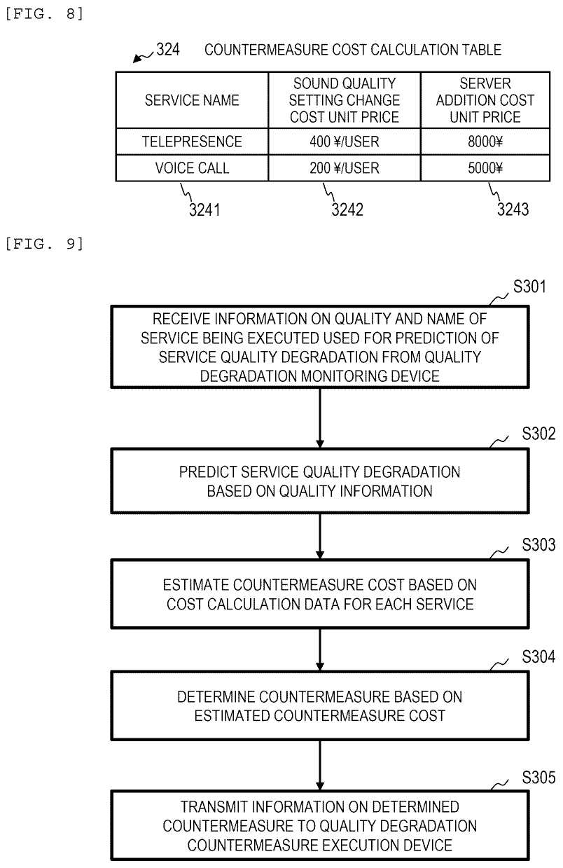

FIG. 8 shows an example of the countermeasure cost calculation table 324 for each service. A service name 3241 is identification information of a service for which a countermeasure cost during the service quality degradation is calculated. A sound quality setting change cost unit price 3242 indicates a unit price of a countermeasure cost required to execute the countermeasure candidate “sound quality setting change” for each service. A server addition cost unit price 3243 indicates a unit price of a countermeasure cost required to execute the countermeasure candidate “server addition” for each service.

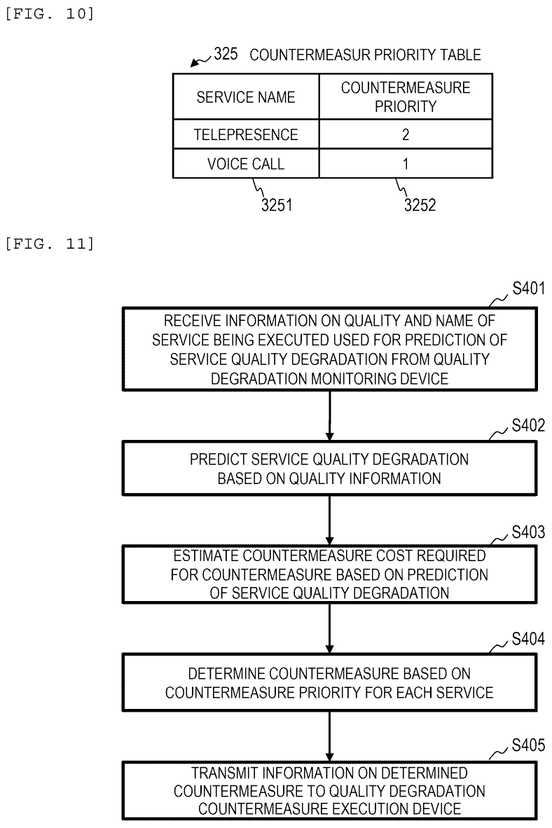

The processing based on Embodiment 3 shown in a flowchart in FIG. 9 is, for example, as follows. The processing of this flowchart is executed, for example, at a predetermined cycle.
Step S301: The processor 30 receives the information indicating the name of the service being executed in addition to the information in step S101. The information indicating the name of the service being executed may be, for example, a numerical value or a character string unique to each service.
Step S302: The prediction unit 311 predicts service quality degradation based on the quality information in the same manner as in step S102.
Step S303: The countermeasure cost estimation unit 312 estimates, based on the cost calculation data for each service, a countermeasure cost required for a countermeasure. For example, it is assumed that the countermeasure cost calculation data for each service is expressed as the countermeasure cost calculation table 324 shown in FIG. 8, and the countermeasure cost table 322 is expressed as shown in FIG. 6.

When the information indicating the service name received in step S301 corresponds to “voice call”, the value of “countermeasure cost unit price” of “sound quality setting change” in the countermeasure cost table 322 used for estimation of the countermeasure cost in step S103 may be changed to “200¥/user” corresponding to “sound quality setting change cost unit price” of “voice call” in the countermeasure cost calculation table 324, the value of “countermeasure cost unit price” of “server addition” in the countermeasure cost table 322 may be changed to “5000¥” corresponding to “server addition cost unit price” of “voice call” in the countermeasure cost calculation table 324, and the countermeasure cost may be estimated in the same manner as in step 103.
Step S304: the countermeasure determination unit 313 determines the countermeasure in the same manner as in step S104.
Step S305: The processor 30 transmits information on the determined countermeasure to the quality degradation countermeasure execution device 2 in the same manner as in step S105.

### Embodiment 4

In the present embodiment, the determination of countermeasure by the countermeasure determination unit 313 according to Embodiment 1 is executed based on a countermeasure priority for each service. Accordingly, for example, when quality degradation of a plurality of services is likely to occur at the same time, it is possible to select a countermeasure that prioritizes a service having a high countermeasure priority, and therefore, an effect of executing a countermeasure suitable for a policy for each service is expected.

In Embodiment 4, for example, information indicating a name of a service being executed is received in step S101 in the flowchart of Embodiment 1 shown in FIG. 5, and processing of executing determination of a countermeasure based on a countermeasure priority for each service is added in step S104.

FIG. 10 shows an example of the countermeasure priority table 325 for each service. A service name 3251 is identification information of a service for which a countermeasure is determined during the service quality degradation. A countermeasure priority 3252 indicates, for each service, a priority for executing a countermeasure during the service quality degradation. The countermeasure priority is preset. For example, the value of the countermeasure priority may be set to be smaller as the priority for executing the countermeasure during the service quality degradation is higher.

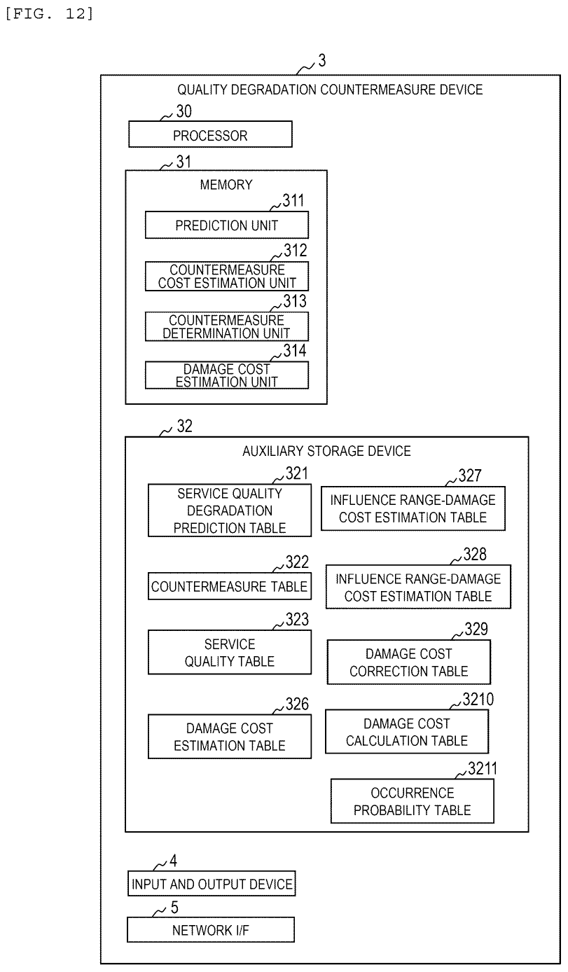

The processing based on Embodiment 4 shown in a flowchart in FIG. 11 is, for example, as follows. The processing of this flowchart is executed, for example, at a predetermined cycle.
Step S401: The processor 30 receives the information indicating the name of the service being executed in addition to the information in step S101. The information indicating the name of the service being executed may be, for example, a numerical value or a character string unique to each service.
Step S402: The prediction unit 311 predicts service quality degradation based on the quality information in the same manner as in step S102.
Step S403: The countermeasure cost estimation unit 312 estimates, based on the prediction of the service quality degradation, a countermeasure cost required for a countermeasure in the same manner as in step S103.
Step S404: The countermeasure determination unit 313 determines the countermeasure based on the countermeasure cost estimated in step S403 and the countermeasure priority for each service. In the determination of the countermeasure based on the countermeasure priority for each service, for example, it is assumed that the quality item for which the service quality degradation is predicted in step S402 is “sound quality”, the countermeasure priority for each service when the “sound quality” degrades is expressed as in the countermeasure priority table 325 shown in FIG. 10, and information corresponding to “telepresence” and “voice call” is included in the information indicating the service name received in step S401.

The countermeasure determination unit 313 may compare the values of the countermeasure priority 3252 in the countermeasure priority table 325 between “telepresence” and “voice call”, and give priority to the determination of the countermeasure of “voice call” having a smaller value. Here, the determination of the countermeasure for “telepresence” having a larger value may be performed, for example, after the determination of the countermeasure for “voice call” having a smaller value.
Step S405: The processor 30 transmits information on the determined countermeasure to the quality degradation countermeasure execution device 2 in the same manner as in step S105.

### Embodiment 5

In the present embodiment, the damage cost that occurs during the service quality degradation is estimated after the prediction of the service quality degradation by the prediction unit 311 according to Embodiment 1 and before the estimation of the countermeasure cost by the countermeasure cost estimation unit 312. Accordingly, a countermeasure corresponding to the damage cost that occurs during the service quality degradation can be selected, and therefore, an effect of reducing the total cost in terms of both the damage and the countermeasure is expected.

In Embodiment 5, for example, a damage cost estimation unit 314 is added to the configuration example in FIG. 1. In addition, for example, a step of estimating the damage cost that occurs during the service quality degradation is added after step S102 and before step S103 in the flowchart of Embodiment 1 shown in FIG. 5. In step S104, the countermeasure is determined based on the damage cost and the countermeasure cost.

The quality degradation countermeasure system including the damage cost estimation unit 314 in FIG. 12 includes the quality degradation monitoring device 1, the quality degradation countermeasure device 3, the quality degradation countermeasure execution device 2, and the interface device 4.

The quality degradation monitoring device 1 acquires information used for prediction of the service quality degradation. The quality degradation countermeasure device 3 predicts service quality degradation, estimates a damage cost that occurs during the service quality degradation, estimates a countermeasure cost required for the countermeasure based on the prediction of the service quality degradation, and determines the countermeasure based on the estimated countermeasure cost. The quality degradation countermeasure execution device 2 executes the quality degradation countermeasure. The interface device 4 displays a prediction result of the service quality degradation, an estimation result of the damage cost, an estimation result of the countermeasure cost, and a determination result of the quality degradation countermeasure.

The quality degradation countermeasure device 3 includes the damage cost estimation unit 314 in addition to the program shown in FIG. 1. The processor 30 can store information received from the quality degradation monitoring device 1 in the auxiliary storage device 32.

Examples of the information stored in the auxiliary storage device 32 include the service quality degradation prediction table 321, the countermeasure cost table 322 that stores estimation of countermeasure cost and determination of a countermeasure, and the service quality prediction table 323 based on a communication state and a device state. Further, examples thereof include the countermeasure cost calculation table 324 for each service, the countermeasure priority table 325 based on a countermeasure priority for each service, a damage cost estimation table 326, and a service quality-damage cost estimation table 327 based on a degree of predicted service quality degradation.

Examples of the information stored in the auxiliary storage device 32 further include an influence range-damage cost estimation table 328 based on an influence range of predicted service quality degradation, a damage cost correction table 329 indicating information for correcting a damage cost when the service quality degradation is not permitted, a damage cost calculation table 3210 for each service, and an occurrence probability table 3220 indicating an occurrence probability of the service quality degradation.

The information stored in the auxiliary storage device 32 may be read, written, and rewritten by the interface device 4. Note that this configuration is merely an example, and there is no restriction on the physical configuration. For example, the quality degradation countermeasure device 3 may have a physical configuration mounted on the same device as the quality degradation monitoring device 1, the quality degradation countermeasure execution device 2, or the interface device 4.

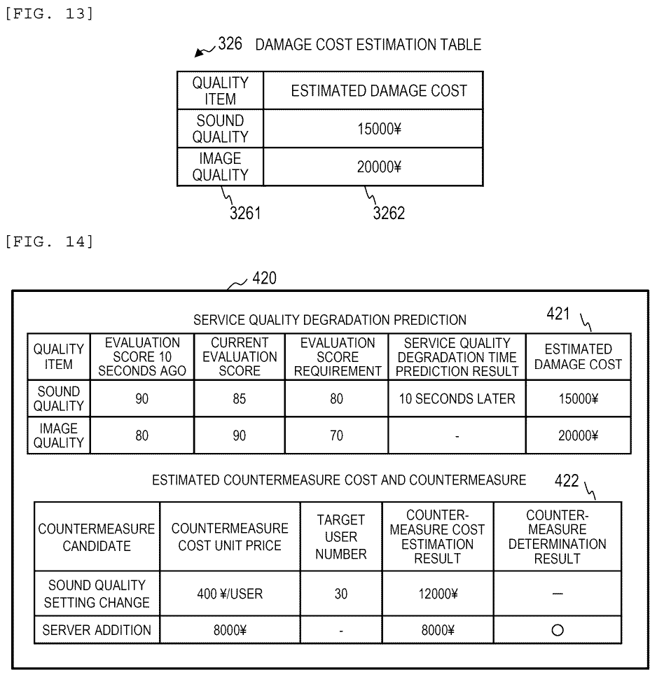

FIG. 13 is an example of the damage cost estimation table 326. A quality item 3261 is identification information of an item for which the damage cost is estimated during the service quality degradation. An estimated damage cost 3262 is an estimated value of the damage cost that occurs during the service quality degradation of each quality item. A value of the estimated damage cost 3262 for each item of the quality item 3261 is preset.

FIG. 14 shows an example of a display screen 420 of a countermeasure determination result including the estimated damage cost, which is shown in the interface device 4. The screen 420 includes a service quality degradation prediction 421 and an estimated countermeasure cost and countermeasure 422. The service quality degradation prediction 421 includes an estimated damage cost column in addition to the column of the service quality degradation prediction table 321.

In the service quality degradation prediction 421, the quality item is identification information of an item for which the service quality degradation is predicted. The evaluation score 10 seconds ago is a score obtained by evaluating the service quality of each quality item 10 seconds ago. The current evaluation score is a score obtained by currently evaluating the service quality of each quality item. The evaluation score requirement is a score at or below which the service quality is determined to degrade when score obtained by evaluating the service quality of each quality item falls.

The service quality degradation time point prediction result is a value indicating, as a result of the prediction of the service quality degradation, how much time is expected from now before the service quality degrades. A method for predicting the service quality degradation will be described below. An estimated damage cost is an estimated value of the damage cost that occurs during the service quality degradation of each quality item.

The estimated countermeasure cost and countermeasure 422 has a countermeasure determination result column in addition to the column of the countermeasure cost table 322. In the estimated countermeasure cost and countermeasure 422, the countermeasure candidate is identification information of a candidate of a countermeasure for preventing service quality degradation. The countermeasure cost unit price is a unit price of a countermeasure cost required to execute each countermeasure candidate. The target user number is the number of users who are execution targets of each countermeasure candidate. The countermeasure cost estimation result is an estimation result of a countermeasure cost required to execute each countermeasure candidate. A method for estimating the countermeasure cost will be described below. The countermeasure determination result is information indicating which countermeasure candidate has been selected as a countermeasure for preventing service quality degradation. As the countermeasure determination result, for example, “∘” may be set to the selected countermeasure candidate, and “−” may be set to the unselected countermeasure candidate.

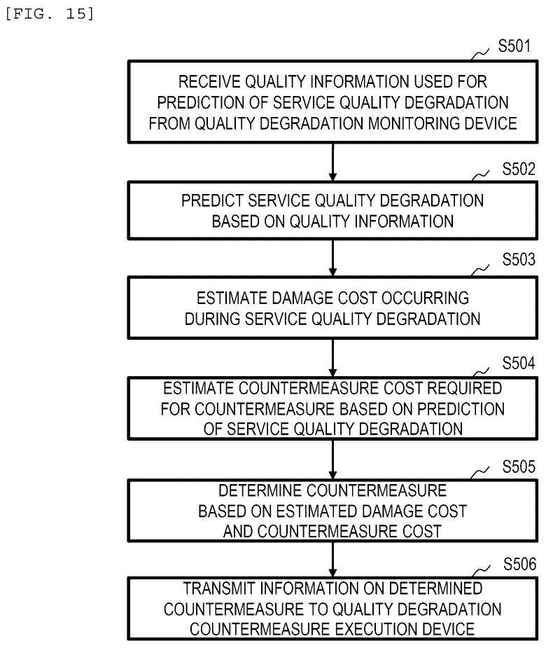

The processing based on Embodiment 5 shown in a flowchart in FIG. 15 is, for example, as follows. The processing of this flowchart is executed, for example, at a predetermined cycle.
Step S501: The processor 30 receives quality information used for prediction of the service quality degradation from the quality degradation monitoring device 1 in the same manner as in step S101.
Step S502: The prediction unit 311 predicts service quality degradation based on the quality information in the same manner as in step S102.
Step S503: The damage cost estimation unit 314 estimates the damage cost that occurs during the service quality degradation. For example, it is assumed that the quality item for which the service quality degradation is predicted in step S502 is “sound quality”, and the estimated damage cost is expressed as in the damage cost estimation table 326 shown in FIG. 13. An estimation result of the damage cost may be the estimated damage cost “15000¥” corresponding to the quality item “sound quality” in the damage cost estimation table 326.
Step S504: The countermeasure cost estimation unit 312 estimates, based on the prediction of the service quality degradation, a countermeasure cost required for a countermeasure in the same manner as in step S103.
Step S505: The countermeasure determination unit 313 determines a countermeasure based on the damage cost estimated in step S503 and the countermeasure cost estimated in step S504. For example, the countermeasure may be determined by comparing the countermeasure cost estimation results estimated in step S504 between the countermeasure candidates and comparing the countermeasure cost estimation results of the countermeasure candidate having the smallest countermeasure cost estimation result with the damage cost estimated in step S503.

For example, the countermeasure cost estimation result estimated in step S504 is expressed as in the countermeasure cost table 322 shown in FIG. 3, and the damage cost estimated in step S503 is expressed as in the damage cost estimation table 326 shown in FIG. 13. When the countermeasure cost estimation result “12000¥” of the countermeasure candidate “sound quality setting change” is compared with the countermeasure cost estimation result “8000¥” of the countermeasure candidate “server addition”, the countermeasure cost estimation result of the countermeasure candidate “server addition” having the minimum countermeasure cost estimation result is “8000¥”.

On the other hand, the damage cost estimated in step S503 is “15000¥”, and the countermeasure cost is “8000¥”, which is lower, and therefore, the countermeasure candidate “server addition” may be determined as the countermeasure. Here, when the countermeasure cost is higher than the damage cost in the case where the countermeasure is not performed, a countermeasure candidate “−” indicating that the countermeasure is not executed may be determined as the countermeasure. The determination result of the countermeasure may be displayed on the interface device 4, for example, as shown in FIG. 14.
Step S506: The processor 30 transmits information on the determined countermeasure to the quality degradation countermeasure execution device 2 in the same manner as in step S105.

### Embodiment 6

In the present embodiment, the estimation of the damage cost that occurs during the service quality degradation by the damage cost estimation unit 314 according to Embodiment 5 is executed based on a degree of the predicted service quality degradation. Accordingly, for example, when the damage cost changes depending on the degree of service quality degradation, the damage cost can be estimated based on the degree of the predicted service quality degradation, and therefore, an effect of improving the estimation accuracy of the damage cost is expected.

In Embodiment 6, for example, processing of executing estimation of the damage cost based on the degree of the predicted service quality degradation is added in step S503 in the flowchart of Embodiment 5 shown in FIG. 15.

FIG. 16 shows an example of the service quality-damage cost estimation table 327 based on the degree of the predicted service quality degradation. A sound quality evaluation score 3271 is a score at or below which a damage cost is estimated to occur when the score obtained by evaluating the service quality of the quality item “sound quality” falls. An estimated damage cost 3272 is a damage cost estimated to occur when the score obtained by evaluating the service quality of the quality item “sound quality” is equal to or less than the value of “sound quality evaluation score” in the same row. A value of the estimated damage cost 3272 for each value of the sound quality evaluation score 3271 is preset.

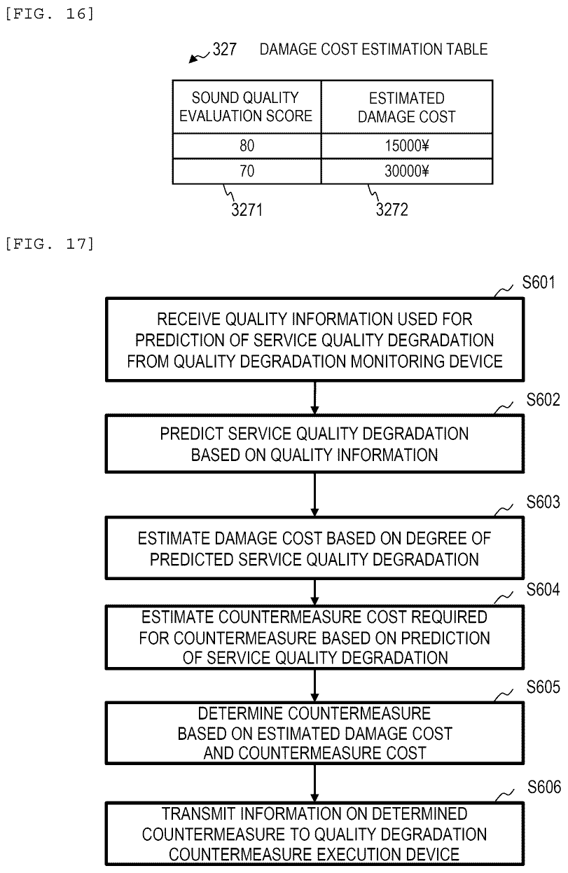

The processing based on Embodiment 6 shown in a flowchart in FIG. 17 is, for example, as follows. The processing of this flowchart is executed, for example, at a predetermined cycle.
Step S601: The processor 30 receives quality information used for prediction of the service quality degradation from the quality degradation monitoring device 1 in the same manner as in step S101.
Step S602: The prediction unit 311 predicts a service quality degradation based on the quality information in the same manner as in step S102.
Step S603: The damage cost estimation unit 314 estimates, based on the degree of the predicted service quality degradation, a damage cost that occurs during service quality degradation. The estimated damage cost based on the degree of service quality degradation can be shown in, for example, the service quality-damage cost estimation table 327 shown in FIG. 16.

When an evaluation score for the quality item “sound quality” is 80 or less, a penalty of “¥10000” is generated when the high-sound quality plan cannot be used. Further, when the evaluation score is equal to or less than 70, a penalty of “¥30000” may be generated when the low-sound quality plan cannot be used.

Estimation of the damage cost based on the degree of the predicted service quality degradation will be described. For example, it is assumed that the quality item for which the service quality degradation is predicted in step S602 is “sound quality”, the evaluation score of “sound quality” is predicted to be 80 or less after 10 seconds as in the prediction table 321 shown in FIG. 2, and the estimated damage cost based on the degree of the service quality degradation is expressed as in the service quality-damage cost estimation table 327 shown in FIG. 16. The damage cost estimation unit 314 may estimate, as the damage cost, the estimated damage cost “15000¥” corresponding to the evaluation score “80” of the sound quality in the service quality-damage cost estimation table 327.
Step S604: The countermeasure cost estimation unit 312 estimates, based on the prediction of the service quality degradation, a countermeasure cost required for a countermeasure in the same manner as in step S103.
Step S605: The countermeasure determination unit 313 determines a countermeasure in the same manner as in step S505.
Step S606: The processor 30 transmits information on the determined countermeasure to the quality degradation countermeasure execution device 2 in the same manner as in step S105.

### Embodiment 7

In the present embodiment, the estimation of the damage cost that occurs during the service quality degradation by the damage cost estimation unit 314 according to Embodiment 5 is executed based on an influence range of the predicted service quality degradation. Accordingly, for example, when the damage cost changes depending on the influence range of the service quality degradation, the damage cost can be estimated based on the influence range of the predicted service quality degradation, and therefore, an effect of improving the estimation accuracy of the damage cost is expected. The influence range of the service quality degradation may be determined for each server or site.

In Embodiment 7, for example, processing of executing estimation of the damage cost based on the influence range of the predicted service quality degradation is added in step S503 in the flowchart of Embodiment 5 shown in FIG. 15.

FIG. 18 shows an example of the influence range-damage cost estimation table 328 indicating an estimated damage cost based on the influence range of the predicted service quality degradation. A sound quality degradation influence range 3281 is identification information on a service in which a damage cost is estimated to occur when the service quality of the quality item “sound quality” degrades. An estimated damage cost 3282 is a damage cost estimated to occur when the service indicated by the “sound quality degradation influence range” in the same row is being executed in a case where the service quality of the quality item “sound quality” degrades. A value of the estimated damage cost 3282 for each value of the sound quality degradation influence range 3281 is preset.

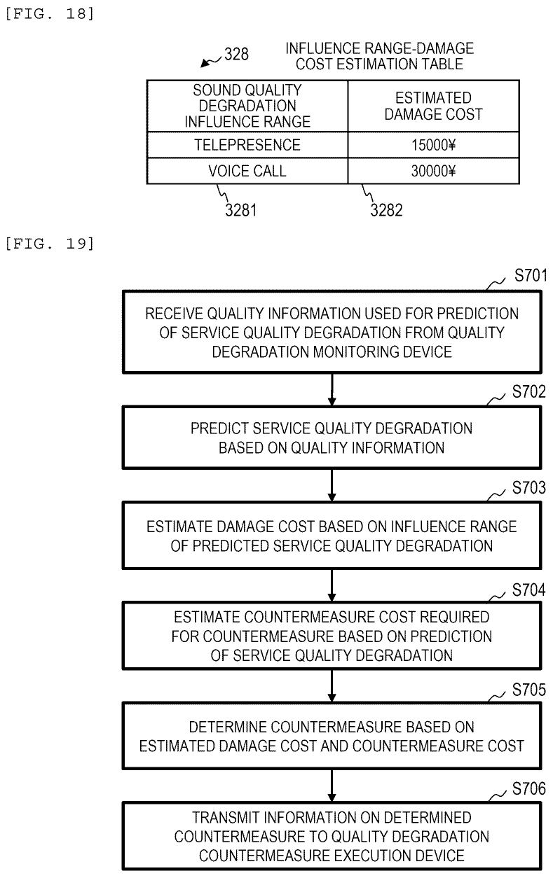

The processing based on Embodiment 7 shown in a flowchart in FIG. 19 is, for example, as follows. The processing of this flowchart is executed, for example, at a predetermined cycle.
Step S701: The processor 30 receives the information indicating the name of the service being executed in addition to the information in step S101. The information indicating the name of the service being executed may be, for example, a numerical value or a character string unique to each service.
Step S702: The prediction unit 311 predicts service quality degradation based on the quality information in the same manner as in step S102.
Step S703: The damage cost estimation unit 314 estimates, based on the influence range of the predicted service quality degradation, the damage cost that occurs during the service quality degradation. As the influence range of the predicted service quality degradation, for example, a service name in which a damage cost occurs when the quality degrades may be set for each quality item. For example, as in the influence range-damage cost estimation table 328 shown in FIG. 18, a service name in which the damage cost occurs when the quality of the quality item “sound quality” degrades may be set to “telepresence” or “voice call”.

Estimation of the damage cost based on the influence range of the predicted service quality degradation will be described. For example, it is assumed that the quality item for which the service quality degradation is predicted in step S702 is “sound quality”, and the estimated damage cost based on the influence range of the predicted service quality degradation is expressed as in the influence range-damage cost estimation table 328 shown in FIG. 18.

The estimated damage cost may be the sum of the estimated damage costs corresponding to the services included in the information indicating the service names received in step S701 among the service names “telepresence” and “voice call” included in the sound quality degradation influence range 3281 of the influence range-damage cost estimation table 328. For example, when the information indicating the service name received in step S701 includes information corresponding to “telepresence” and “voice call”, the estimated damage cost may be 10000+30000=40000¥.
Step S704: The countermeasure cost estimation unit 312 estimates, based on the prediction of the service quality degradation, a countermeasure cost required for a countermeasure in the same manner as in step S103.
Step S705: The countermeasure determination unit 313 determines a countermeasure in the same manner as in step S505.
Step S706: The processor 30 transmits information on the determined countermeasure to the quality degradation countermeasure execution device 2 in the same manner as in step S105.

### Embodiment 8

In the present embodiment, in the estimation of the damage cost that occurs during the service quality degradation by the damage cost estimation unit 314 according to Embodiment 5, the damage cost is corrected when the service quality degradation is not permitted. Accordingly, for example, when service quality degradation is not permitted due to law, ethics, safety, or the like, the damage cost can be corrected so that a countermeasure having a low cost but having a high occurrence probability of service quality degradation is not selected. Therefore, an effect of selecting a countermeasure having a low occurrence probability of service quality degradation is expected without changing the logic itself of the countermeasure determination.

In Embodiment 8, for example, when the service quality degradation is not permitted, processing of correcting the damage cost is added in step S503 in the flowchart of Embodiment 6 shown in FIG. 15.

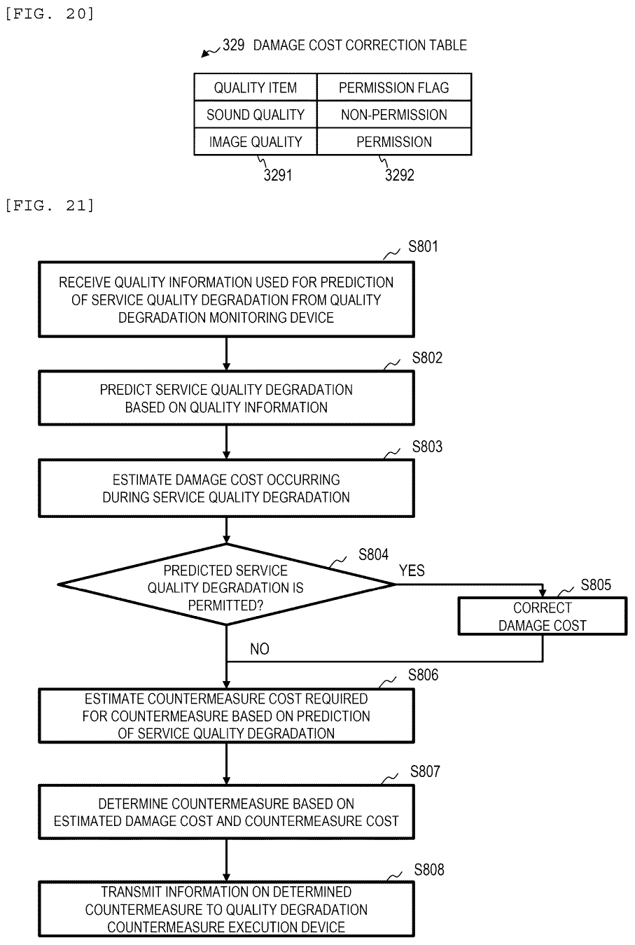

FIG. 20 shows an example of the damage cost correction table 329 indicating whether service quality degradation is permitted. A quality item 3291 is identification information of an item for which a damage cost is estimated during the service quality degradation. A permission flag 3292 is information indicating whether service quality degradation is permitted for reasons such as law, ethics, and safety. The information on whether to permit the service quality degradation is preset.

The processing based on Embodiment 8 shown in a flowchart in FIG. 21 is, for example, as follows. The processing of this flowchart is executed, for example, at a predetermined cycle.
Step S801: The processor 30 receives quality information used for prediction of the service quality degradation from the quality degradation monitoring device 1 in the same manner as in step S101.
Step S802: The prediction unit 311 predicts service quality degradation based on the quality information in the same manner as in step S102.
Step S803: The damage cost estimation unit 314 estimates a damage cost that occurs during the service quality degradation, in the same manner as in step S503.
Step S804: The damage cost estimation unit 314 determines whether the service quality degradation predicted in step S802 is permitted with reference to the information on whether to permit the service quality degradation. As a result of the determination, if it is permitted, the processing proceeds to step S806, and if it is not permitted, the processing proceeds to step S805.

In the determination of whether the service quality degradation predicted in step S802 is permitted, for example, when the quality item for which the service quality degradation is predicted in step S802 is “sound quality” and permission/non-permission of the service quality degradation is expressed as in the damage cost correction table 329 shown in FIG. 20, the determination result may be “not permitted” from the permission flag “non-permission” corresponding to the quality item “sound quality” of the damage cost correction table 329.
Step S805: The damage cost estimation unit 314 corrects the damage cost based on the service quality degradation predicted in step S802, and proceeds to step S807. For example, the correction of the damage cost may be set to “∞” indicating that the countermeasure is always executed regardless of the countermeasure cost, or an upper limit amount of money that may be used as the countermeasure cost may be set.
Step S806: The countermeasure cost estimation unit 312 estimates, based on the prediction of the service quality degradation, countermeasure cost required for a countermeasure in the same manner as in step S103.
Step S807: the countermeasure determination unit 313 determines a countermeasure in the same manner as in step S505. For example, when the damage cost is set to “∞” in step S805, the countermeasure cost estimated in step S806 is always lower, and therefore, a countermeasure candidate having the minimum countermeasure cost may be determined as a countermeasure.
Step S808: The processor 30 transmits information on the determined countermeasure to the quality degradation countermeasure execution device 2 in the same manner as in step S105.

### Embodiment 9

In the present embodiment, the estimation of the damage cost that occurs during the service quality degradation by the damage cost estimation unit 314 according to Embodiment 5 is executed based on the cost calculation data for each service. Accordingly, the cost calculation data suitable for each service can be referred to, and therefore, an effect of improving the estimation accuracy of the damage cost is expected.

In Embodiment 9, for example, processing of executing estimation of the damage cost based on the cost calculation data for each service is added in step S503 in the flowchart of Embodiment 5 shown in FIG. 15.

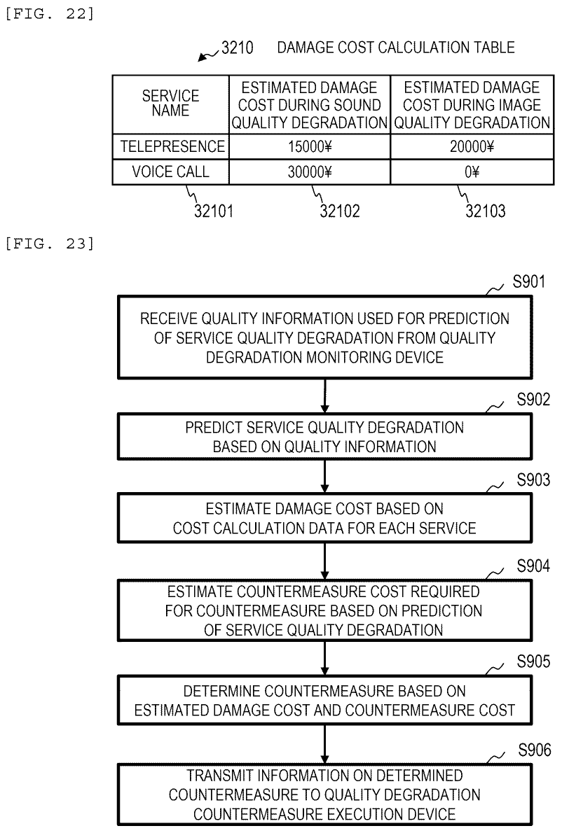

FIG. 22 shows an example of the damage cost calculation table 3210 for each service. A service name 32101 is identification information of a service for which a damage cost during the service quality degradation is calculated. An estimated damage cost 32102 during sound quality degradation indicates, for each service, an estimated value of the damage cost generated when the quality item “sound quality” degrades. An estimated damage cost 32103 during image quality degradation indicates, for each service, an estimated value of the damage cost generated when the quality item “image quality” degrades.

The processing based on Embodiment 9 shown in a flowchart in FIG. 23 is, for example, as follows. The processing of this flowchart is executed, for example, at a predetermined cycle.
Step S901: The processor 30 receives the information indicating the name of the service being executed in addition to the information in step S101. The information indicating the name of the service being executed may be, for example, a numerical value or a character string unique to each service.
Step S902: The prediction unit 311 predicts service quality degradation based on the quality information in the Same manner as in step S102.
Step S903: The damage cost estimation unit 314 estimates, based on the cost calculation data for each service, the damage cost that occurs during the service quality degradation. For example, it is assumed that the damage cost calculation data for each service is expressed as in the damage cost calculation table 3210 shown in FIG. 22, the damage cost estimation table 326 is expressed as in FIG. 13, and the information indicating the service name received in step S901 corresponds to “voice call”.

In the estimation of the damage cost based on the cost calculation data for each service, a value of the estimated damage cost 3262 of the “sound quality” in the damage cost estimation table 326 may be changed to “30000¥” corresponding to the estimated damage cost 32102 during sound quality degradation of the “voice call” in the damage cost calculation table 3210, and a value of the estimated damage cost 3262 of the “image quality” in the damage cost estimation table 326 may be changed to “0¥” corresponding to the estimated damage cost 32103 during image quality degradation of “voice call” in the damage cost calculation table 3210.
Step S904: The countermeasure cost estimation unit 312 estimates, based on the prediction of the service quality degradation, a countermeasure cost required for a countermeasure in the same manner as in step S103.
Step S905: the countermeasure determination unit 313 determines a countermeasure in the same manner as in step S505.
Step S906: The processor 30 transmits information on the determined countermeasure to the quality degradation countermeasure execution device 2 in the same manner as in step S105.

### Embodiment 10

In the present embodiment, the determination of the countermeasure by the countermeasure determination unit 313 according to Embodiment 5 is executed based on an occurrence probability of the service quality degradation. Accordingly, it is possible to estimate the damage cost and the countermeasure cost based on the occurrence probability of the service quality degradation and determine a countermeasure, and therefore, an effect of reducing a total cost is expected.

In Embodiment 10, for example, determination of the countermeasure is executed based on the occurrence probability of the service quality degradation in step S505 in the flowchart of Embodiment 5 shown in FIG. 15.

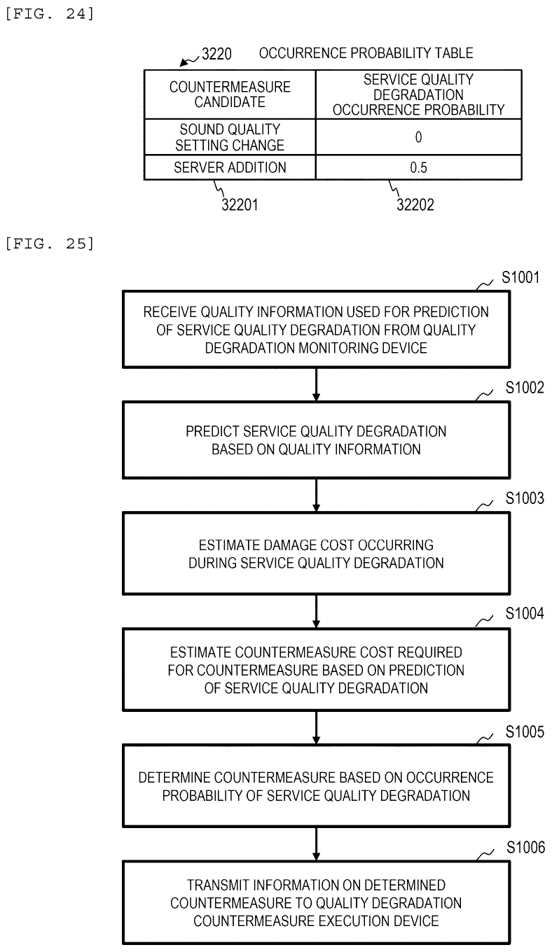

FIG. 24 shows an example of the occurrence probability table e 3220 indicating a relation between a countermeasure candidate and an occurrence probability of service quality degradation. A countermeasure candidate 32201 is identification information of a candidate for a countermeasure for preventing the service quality degradation. A service quality degradation occurrence probability 32202 is a probability at which the service quality degradation occurs even when each countermeasure candidate is executed. The information on the relation between the countermeasure candidate and the occurrence probability of the service quality degradation is preset.

The processing based on Embodiment 10 shown in a flowchart in FIG. 25 is, for example, as follows. The processing of this flowchart is executed, for example, at a predetermined cycle.
Step S1001: The processor 30 receives quality information used for prediction of the service quality degradation from the quality degradation monitoring device 1 in the same manner as in step S101.
Step S1002: The prediction unit 311 predicts service quality degradation based on the quality information in the same manner as in step S102.
Step S1003: The damage cost estimation unit 314 estimates a damage cost that occurs during the service quality degradation, in the same manner as in step S503.
Step S1004: The countermeasure cost estimation unit 312 estimates, based on the prediction of the service quality degradation, a countermeasure cost required for a countermeasure in the same manner as in step S103.
Step S1005: The countermeasure determination unit 313 determines a countermeasure based on the countermeasure cost estimated in step S1003 and the occurrence probability of the service quality degradation. The determination of the countermeasure based on the occurrence probability of the service quality degradation may be performed using, for example, an evaluation function based on the occurrence probability of the service quality degradation.

In an evaluation function E based on the occurrence probability of the service quality degradation, an expected value of an effect of reducing the damage cost by the execution of the countermeasure candidate is represented by (1−P)×L based on, for example, a service quality degradation occurrence probability P when each countermeasure candidate is executed and a damage cost L when the service quality degradation occurs. Further, M−(1−P)×L representing the total cost may be set using the countermeasure cost M necessary for executing the countermeasure candidate.

For example, it is assumed that the occurrence probability of the service quality degradation is expressed as in the occurrence probability table 3220 shown in FIG. 24, and the quality item for which the service quality degradation is predicted in step S1002 is “sound quality”. In addition, the estimated damage cost in step S1003 is expressed as in the damage cost estimation table 326 shown in FIG. 13. Further, it is assumed that the countermeasure cost estimated in step S1004 is expressed as in the countermeasure cost table 322 shown in FIG. 3.

The service quality degradation occurrence probability 32202 “0%” of the countermeasure candidate 32201 “sound quality setting change” in the occurrence probability table 3220, the estimated damage cost 3262 “15000¥” of the quality item “sound quality” in the damage cost estimation table 326, and the countermeasure cost estimation result 3224 “12000¥” of the countermeasure candidate 3221 “sound quality setting change” in the countermeasure cost table 322 are substituted into the evaluation function E. Then, the evaluation function E of the countermeasure candidate 32201 “sound quality setting change” becomes E=12000−(1−0)×15000=(−3000).

Similarly, when the countermeasure candidate 32201 “server addition” is substituted into the evaluation function E, the evaluation function E of the countermeasure candidate 32201 “server addition”=8000−(1−0.5)×15000=500. From this result, “sound quality setting change”, which is a countermeasure candidate having the smallest value of the evaluation function E, may be determined as a countermeasure.
Step S1006: The processor 30 transmits information on the determined countermeasure to the quality degradation countermeasure execution device 2 in the same manner as in step S105. For example, when the countermeasure candidate determined as the countermeasure in step S1005 is “sound quality setting change”, the sound quality may be switched to the normal sound quality for a user who uses a service with high sound quality, such as a subscriber of a high-sound quality plan.

The invention is not limited to the embodiments described above, and includes various modifications. For example, the embodiments described above are described in detail to facilitate understanding of the invention, and the invention is not necessarily limited to those including all the configurations described above. A part of a configuration of a certain embodiment can be replaced with a configuration of another embodiment, and the configuration of another embodiment can be added to a configuration of a certain embodiment. In addition, with respect to a part of a configuration of each embodiment, addition, deletion, or replacement of another configuration can be applied singly or in combination.

Some or all of the configurations, functions, processing units, processing methods, and the like described above may be implemented by hardware by, for example, designing with an integrated circuit. In addition, the above configurations, functions, and the like may be implemented by software by a processor interpreting and executing a program for implementing each function. Information such as a program, a table, and a file for implementing each function can be stored in a recording device such as a memory, a hard disk, or a solid state drive (SSD), or in a recording medium such as an IC card, an SD card, or a DVD.

Control lines and information lines indicate what is considered to be necessary for description, and not necessarily all control lines and information lines are always shown on a product. Actually, it may be considered that almost all the configurations are connected to each other.

1. A method for determining, by a system, a countermeasure against quality degradation in a service provided by a service provision device, wherein
the system stores countermeasure cost information indicating a relation between a countermeasure candidate and a cost,
the method comprising, by the system:
predicting service quality degradation based on monitoring information of service quality;
estimating, based on the countermeasure cost information, a countermeasure cost required for each countermeasure candidate of a quality item for which the service quality degradation is predicted; and
determining the countermeasure based on the estimated countermeasure cost.

2. The method according to claim 1, wherein
the system predicts the service quality degradation based on at least one of a state of communication for providing the service and a state of the service provision device.

3. The method according to claim 1, wherein
the countermeasure cost information indicates a relation between the countermeasure candidate and the cost for each service,
the method further comprising, by the system:
predicting service quality degradation in a service being executed; and
estimating, based on the countermeasure cost information, the countermeasure cost of the service being executed.

4. The method according to claim 1, wherein
the system stores countermeasure priority information indicating a countermeasure priority for each service,
the method further comprising, by the system:
predicting service quality degradation in a plurality of services being executed; and
determining, based on the countermeasure priority information, a service being executed as a countermeasure.

5. The method according to claim 1, wherein
the system stores damage cost estimation information indicating a relation between a service quality item and an estimated damage cost,
the method further comprising, by the system:
estimating, based on the damage cost estimation information, a damage cost of the quality item for which the service quality degradation is predicted, and
determining the countermeasure based on the estimated countermeasure cost and the estimated damage cost.

6. The method according to claim 5, wherein
the damage cost estimation information indicates a relation between a degree of service quality degradation and a damage cost,
the method further comprising, by the system:
estimating the damage cost based on a degree of predicted service quality degradation with reference to the damage cost estimation information.

7. The method according to claim 5, wherein
the system stores influence range information indicating a relation between an influence range of service quality degradation and an estimated damage cost,
the method further comprising, by the system:
estimating the damage cost based on an influence range of predicted service quality degradation with reference to the influence range information.

8. The method according to claim 5, wherein
the system increases a damage cost of a quality item for which service quality degradation is not permitted.

9. The method according to claim 5, wherein
the countermeasure cost information indicates a relation between the countermeasure candidate and the cost for each service, and
the damage cost estimation information indicates a relation between the service quality item and the estimated damage cost for each service,
the method comprising, by the system:
predicting service quality degradation in a service being executed;
estimating, based on the countermeasure cost information, the countermeasure cost of the service being executed; and
estimating, based on the damage cost estimation information, the damage cost of the service being executed.

10. The method according to claim 5, wherein
the system determines the countermeasure based on a service quality degradation occurrence probability of the countermeasure candidate.

11. A system for determining a countermeasure against quality degradation in a service provided by a service provision device, the system comprising:
one or more processors; and
one or more storage devices, wherein
the one or more storage devices store countermeasure cost information indicating a relation between a countermeasure candidate and a cost, and
the one or more processors
predict service quality degradation based on monitoring information of service quality,
estimate, based on the countermeasure cost information, a countermeasure cost required for each countermeasure candidate of a quality item for which the service quality degradation is predicted, and
determine the countermeasure based on the estimated countermeasure cost.

12. The system according to claim 11, wherein
the one or more processors predict the service quality degradation based on at least one of a state of communication for providing the service and a state of the service provision device.

13. The system according to claim 11, wherein
the countermeasure cost information indicates a relation between the countermeasure candidate and the cost for each service, and
the one or more processors
predict service quality degradation in a service being executed, and
estimate, based on the countermeasure cost information, the countermeasure cost of the service being executed.

14. The system according to claim 11, wherein
the one or more storage devices store countermeasure priority information indicating a countermeasure priority for each service, and
the one or more processors
predict service quality degradation in a plurality of services being executed, and
determine, based on the countermeasure priority information, a service being executed as a countermeasure.

15. The system according to claim 11, wherein
the one or more storage devices store damage cost estimation information indicating a relation between a service quality item and an estimated damage cost, and
the one or more processors
estimate, based on the damage cost estimation information, a damage cost of the quality item for which the service quality degradation is predicted, and
determine the countermeasure based on the estimated countermeasure cost and the estimated damage cost.
